(19) United States
(12) Patent Application Publication
(10) Pub. No.: US 2013/0205871 A1
(43) Pub. Date: Aug. 15, 2013

(54) METHOD AND DEVICE FOR DETECTING TRACE AMOUNTS OF MANY GASES

(71) Applicants: Virginie Zeninari, Reims Cedex 2 (FR); Bertrand Parvitte, Reims Cedex 2 (FR); Lilian Joly, Reims Cedex 2 (FR); Georges Durry, Reims Cedex 2 (FR); Ronan Le Loarer, Reims Cedex 2 (FR); Jean Charles Garcia, Reims Cedex 2 (FR); Regis Hamelin, Castelmaurou (FR)

(72) Inventors: Virginie Zeninari, Reims Cedex 2 (FR); Bertrand Parvitte, Reims Cedex 2 (FR); Lilian Joly, Reims Cedex 2 (FR); Georges Durry, Reims Cedex 2 (FR); Ronan Le Loarer, Reims Cedex 2 (FR); Jean Charles Garcia, Reims Cedex 2 (FR); Regis Hamelin, Castelmaurou (FR)

(73) Assignees: AEROVIA, REIMS CEDEX 2 (FR); UNIVERSITE DE REIMS CHAMPAGNE ARDENNE, REIMS CEDEX (FR)

(21) Appl. No.: 13/811,364

(22) PCT Filed: Jul. 21, 2011
(86) PCT No.: PCT/FR2011/051766

§ 371 Date: Apr. 26, 2013

(30) Foreign Application Priority Data
Jul. 21, 2010 (FR) 10 55954

(51) Int. Cl. G01N 21/17

(52) U.S. Cl. CPC G01N 21/1702
USPC 73/24.02

(57) ABSTRACT

The photoacoustic device for measuring the quantity of at least one gas. The Helmholtz-type esonant container comprises at least two tubes closed at their ends and linked together, close to each of their respective ends, by capillary tubes of diameter lower than the diameter of the parallel tubes. Each of the two radiant laser energy sources is physically separated and adapted to supply an excitation energy to the gas in the container at a different emission wavelength. The modulation means modulates the excitation energy supplied by each laser energy source with a modulation frequency corresponding to the acoustic resonance frequency of the container. At least one acoustoelectric transducer disposed on one of the tubes detects the produced acoustic signals produced and supplies an electric signal representative of the gas concentration in the container.

### RELATED APPLICATIONS

This application is a §371 application from PCT/FR2011/051766 filed Jul. 21, 2011, which claims priority from French Patent Application No. 10 55954 filed Jul. 21, 2010, each of which is herein incorporated by reference in its entirety.

### TECHNICAL FIELD OF INVENTION

The present invention concerns a detection method and device for tracing multiple gases.

### BACKGROUND OF THE INVENTION

Gas analysis is one of the key technologies for the environmental and military markets and the medical and scientific fields. Amongst all the techniques employed, the principle of optical analysis is still restricted to specific and niche applications. The main reasons are linked to the complexity of its implementation, the cost of equipment and the equipment's limitation for analysing a given gas.

Amongst the optical techniques, photoacoustic spectroscopy allows for resolving the “complexity” aspects of the instrument and to reach competitive cost levels with conventional technologies. Additionally, the advantages of photoacoustic analysis are numerous: measuring selectivity, sensitivity, precision of the measurement and range of measurement covering all the gases by using a wavelength adapted for optical excitation of the laser.

It is known, as represented in FIG. 1, that the light absorption curve 50, of a determined gas in accordance with the wavelength of light, such as, for example, methane (chemical formula CH₄), presents maximum levels for certain wavelengths λ1, λ2, λ3. Generally, the absorption of energy by a particular gas on a wavelength spectrum includes narrowbands of the highest absorption, spaced out by bands of the weakest absorption. Each gas has a unique absorption spectrum which allows to detect it and/or to measure its concentration in a sample.

The principle of photoacoustic measurement is that the studied gas, in a container, absorbs a part of the energy of the light passing in the container. Each molecule thus increases its mechanical energy, which becomes apparent by an increase in temperature and pressure.

As illustrated in FIG. 2A, in a closed non-resonant container, a variation of pressure 41, represented in ordinates, detected by the signal supplied by an acoustoelectric transducer, generally a microphone, varies in accordance with the wavelength of the light passing through the container, represented on the abscissae.

When we want to carry out a detection or a measurement of concentration of a gas in various places and in real time, we circulate the withdrawn gas in a container open to the outside. In this case, the curve of response of a prior art device in a non-resonant container, presents the curve 42, illustrated in FIG. 2B. We observe in this figure that it is difficult to extract the signal which corresponds to the presence of the considered gas, in the noise. One of the aims of the present invention is to propose a system which can be used as well both in a closed container and in an open container, and which allows the obtaining of a large detection sensitivity, and being easily adaptable to whichever gas.

However, in numerous applications, it is desirable to analyse several gases in a same sample. So, a multiplication of single gas analysis instruments multiplies the volume and the final cost. Additionally, it is desirable to increase the precision and the reliability of the detection of each gas, even for the detection of a single gas.

We know the article “Design and characteristics of a differential helmholtz resonant photoacoustic cell for infrared gas detection” Infrared Physics & Technology Elsevier, Netherlands and the international application WO 03/083455, which describe photoacoustic devices. However, these devices present a limited sensitivity, and only allow the detection of a single type of gas.

### OBJECT AND SUMMARY OF THE INVENTION

The present invention aims to solve these disadvantages.

For this purpose, according to a first aspect, the present invention applies to a photoacoustic measurement device, which measures the quantity of at least one gas, this device comprises of:
a Helmholtz resonant container, composed of at least two closed tubes at their ends and linked together, close to each of their ends, by capillary tubes of a lesser diameter than the diameter of the parallel tubes and
a gas introduction means in the said container.

This device additionally comprises of:
at least two radiant laser energy sources, physically separately adapted, each to supply an excitation energy to the gas in the container, at a different emission wavelength, corresponding to a maximum absorption wavelength locally for a said gas, each said radiant energy source being positioned opposite a window closing a tube end,
a modulation means which modulates the excitation energy supplied by each of the laser energy sources with a modulation frequency, in correspondence with the acoustic resonance frequency of the resonant container and
at least an acoustoelectric transducer disposed on one of the tubes to detect the acoustic signals produced in this tube and to supply an electric signal representative of the concentration of the gas in the container.

Thanks to these dispositions, a single container is enough to have several detections and/or several measurements of gas concentrations, each implementing one of the laser sources. The volume and the cost of the instrument are therefore only partially increased.

According to the operating methods of this device:
either we implement,simultaneously, at least two radiant laser energy sources at two wavelengths characteristic of a same gas, which increases the detection sensitivity of his gas,
or we implement, successively, the radiant laser energy source to wavelengths characteristic of different gases, which allows the fast switching of detecting traces of one gas, to detecting traces of another gas, while using a very reduced volume.

Additionally, we can easily pass from one to the other of these operating methods, by foreseeing radiant laser energy sources which correspond to different absorption peaks of a same gas, and radiant laser energy sources which correspond to different absorption peaks of different gases. So, it is enough to switch between the first and second ones to pass from the first operating method described above to the second.

The present invention thus allows the resolution of the density problem, the multiplicity of analysed gases and the final cost of the instrument.

Thanks to the implementation of a Helmholtz resonant container, we improve the sensitivity of the detection/measurement of gas, notably for very weak concentrations, while using a simple device, easily adaptable for the detection of all types of gas. Additionally, the object device of the present invention can be implemented, mounted onboard a vehicle, while having a high sensitivity. Thus, we can carefully measure the air quality on a vast surface, for example, in the main streets of a city.

According to particular features, the object device of the present invention comprises of at least two radiant laser energy sources, positioned opposite different windows.

According to particular features, the object device of the present invention comprises of at least two radiant laser energy sources, positioned opposite a same window.

According to particular features, the object device of the present invention comprises of at least two radiant laser energy sources of which the emission wavelength corresponds to a maximum absorption wavelength for two different gases.

According to particular features, the object device of the present invention comprises of at least two radiant laser energy sources of which the emission wavelength corresponds to two maximum absorption wavelengths for the same gas.

According to particular features, the object device of the present invention comprises of at least one radiant laser energy source of quantum cascade type.

According to particular features, the object device of the present invention comprises of at least three tubes forming two resonant containers, sharing a tube linked by capillary tubes to two other tubes.

More than two tubes forming at least two Helmholtz containers, sharing a tube allows to reduce substantially the volume and to increase the number of lasers being able to be integrated.

According to particular features, the modulation means successively modulates the excitation energy supplied by each of the laser energy sources.

According to particular features, the modulation means simultaneously modulates the excitation energy supplied by at least two laser energy sources.

According to particular features, the modulation means applies a phase difference of 180° between the excitation energies of the laser energy sources, which are located opposite successive tube windows of the device.

According to particular features, the at least two said laser energy sources have emission wavelengths corresponding to the absorption peaks of the same gas.

According to a second aspect, the present invention applies a photoacoustic measurement method of the quantity of at least one gas while implementing a Helmholtz resonant container, composed of at least two tubes closed at their ends and linked together, close to each of their ends, by capillary tubes of a diameter lower than the diameter of the parallel tubes, and a gas introduction means in the said container.

This method comprises, simultaneously for each of at least two of the radiant energy sources:
a step of modulating the excitation energy supplied by the said radiant laser energy source, with a modulation frequency matching the acoustic resonance frequency of the resonant container, the said radiant laser energy source supplying an excitation energy to the gas in the container, the emission wavelength of the said source corresponding to a maximum absorption wavelength locally for a said gas, the said radiant energy source being positioned opposite a window, closing a tube end,
a step of processing a resulting signal of at least an acoustoelectric transducer, disposed on one of the tubes to detect acoustic signals produced in this tube and to supply an electric signal representative of the gas concentration in the container.

According to particular features, during the modulation step, we simultaneously modulate the excitation energy supplied by at least two laser energy sources.

According to particular features, during the modulation step, we apply a phase difference of 180° between the excitation energies of the laser energy sources which are located opposite the windows of successive tubes.

The advantages, aims and particular features of this method being similar to those of the object device of the present invention, such as succinctly shown above, they are not recalled here.

### BRIEF DESCRIPTION OF THE DRAWINGS

Other advantages, aims and particular features of the present invention will result from the description which will follow, in an explanatory and in no way limiting way, opposite the appended drawings, wherein:

FIG. 1 shows the light absorption spectrums by a gas, in accordance with different light wavelengths,

FIG. 2A shows the response of a non-resonant contained closed on the exterior,

FIG. 2B shows the response of a non-resonant container open on the exterior,

FIG. 3 shows, in diagram form, a particular embodiment of the object device of the present invention,

FIG. 4 shows, in perspective, a Helmholtz resonant container used in the device illustrated in FIG. 3,

FIG. 5A shows the response of the resonant container illustrated in FIG. 4, when it is closed on the exterior,

FIG. 5B shows the response of the resonant container illustrated in FIG. 4, when it is open on the exterior,

FIG. 6 shows, in diagram form and as a view from above, a particular embodiment of the object device of the present invention,

FIG. 7 shows, in diagram form and as a view from above, a particular embodiment of the object device of the present invention,

FIG. 8 shows, in diagram form and as a view from above and the side, the details of the device illustrated in FIG. 7,

FIG. 9 shows, in diagram form and as a view from above, a particular embodiment of the object device of the present invention,

FIG. 10 shows a methane and nitrogen oxide detection curve in the atmosphere, in presence of water vapour,

FIG. 11 shows a signal obtained for different concentrations of known gases,

FIG. 12 shows two methane absorption curves in air flow,

FIG. 13 shows two nitrogen oxide absorption curves,

FIG. 14 shows a calcualted spectrum of absorption of ambient air, containing 100 ppm of nitrogen oxide around 5.4 microns,

FIG. 15 shows a spectrum obtained experimentally in the conditions of FIG. 14 and

FIG. 16 shows, in diagram form, the steps implemented in a particular embodiment of the object method of the present invention.

### DETAILED DESCRIPTION OF THE EMBODIMENTS

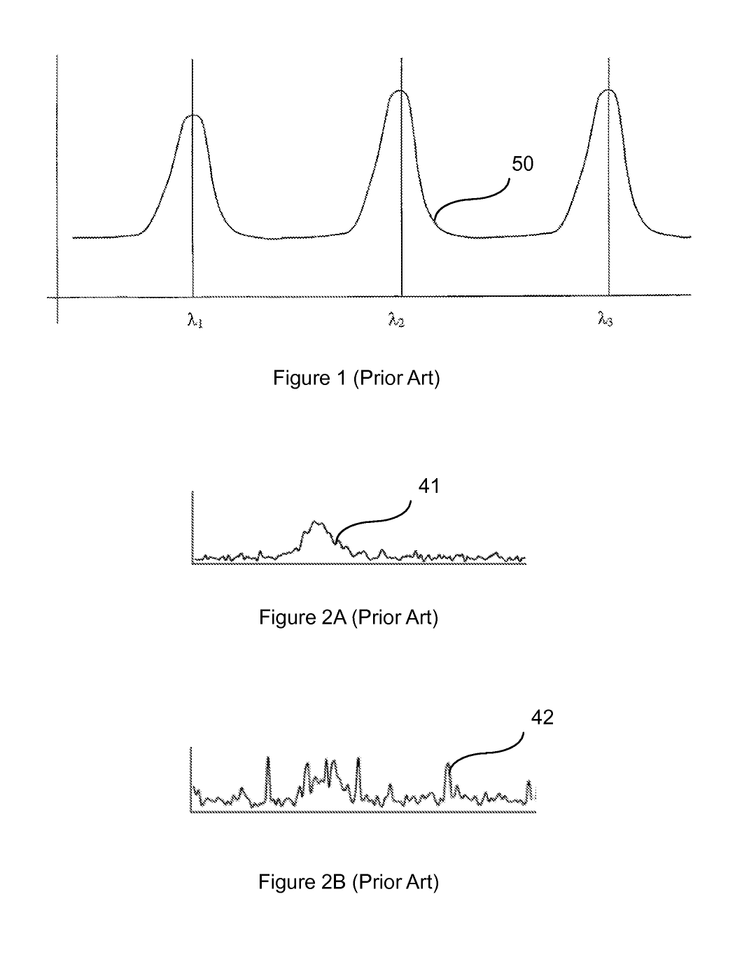

FIGS. 1, 2A and 2B have already been described in the preamble of the present document.

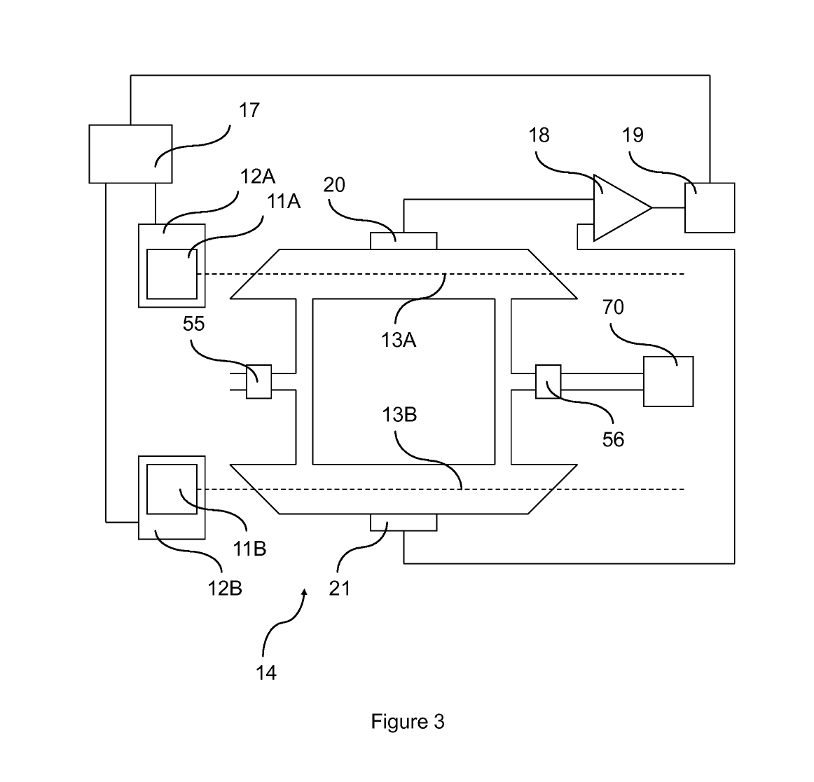

As illustrated in FIG. 3, in a particular embodiment, the object device of the present invention comprises two laser sources 11A and 11B, for example, diode, emitting two laser beams 13A and 13B presenting, each, a wavelength corresponding to an absorption peak of a target gas. Preferentially, at least one light source of infrared laser means, known under the name of “Quantum Cascade Laser” is implemented. The laser technology of quantum cascade (“QCL”) offers a range of lasers in the Infrared means, making wavelengths with a very large set of complex molecules accessible.

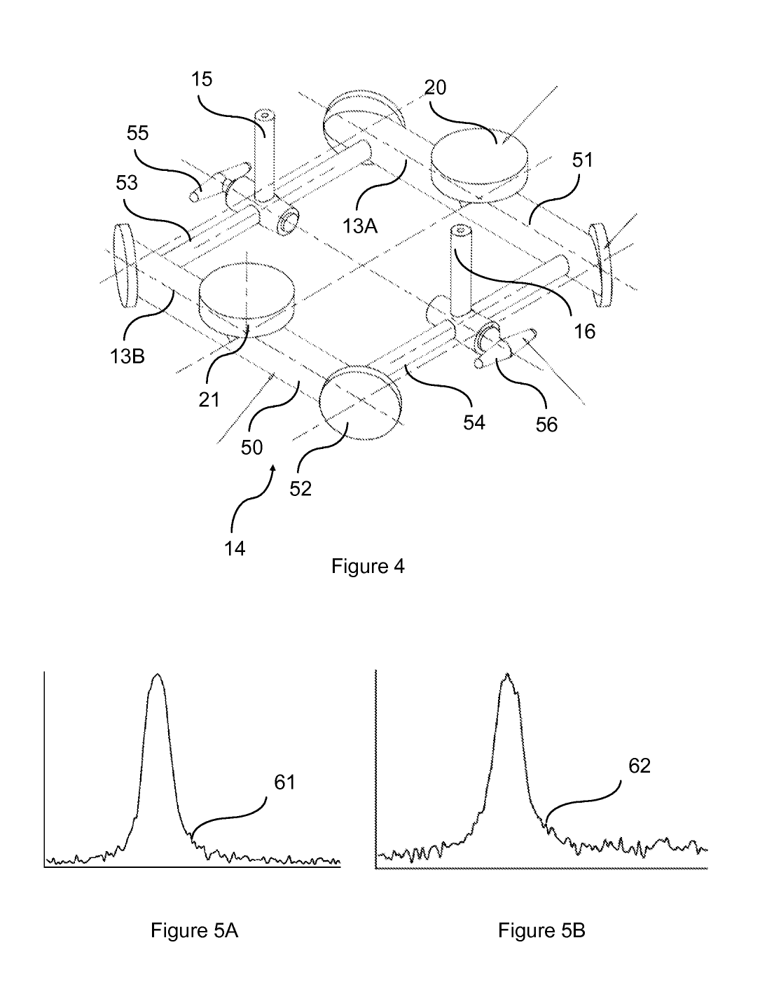

Each laser beam, 13A and 13B is modulated by an electronic or mechanical modulator, 12A and 12B respectively, to be modulated in frequency, to a determined frequency, for example, 210 Hz, corresponding at the frequency of acoustic resonance of the Helmholtz container. Each laser beam 13A and 13B reaches a resonant Helmholtz-type container 14, consisting of, as represented in FIG. 4, two parallel tubes, 50 and 51, closed at their ends by windows 52. These windows 52 allow each laser beam to pass, which thus penetrates in the volume of a tube 50, disposed on its path. The two parallel tubes 50 and 51 are linked close to each of their exteriors, by capillary tubes 53 and 54, of diameter d smaller than diameter D of parallel tubes 50 and 51.

Thus, for example, by choosing tubes of 10 cm in length, and a ratio of the diameter of the capillaries on the diameter of the tubes equal to 1/10, a resonant container of which the frequency of acoustic resonance is 210 Hz is achieved. On each of the parallel tubes 50 and 51, are disposed, in a central area, acoustoelectric transducers, for example, electret microphones, 20 and 21. These microphones have a flat response curve in a range of 100 Hz to 20 KHz. It is noted that it is possible to also use capacitor microphones or MEMS (“MicroElectroMechanical System” for a microelectromechanical system). The type of transducer used is, for example, supplied by the company “Knowles” (registered trademark), under the reference “K 1024” or by one of the companies “Sennheiser” (registered trademark) or “Brüel & Kjaer” (registered trademark). The first capillary 53 is equipped with an entry tube 15. The second capillary 54 is equipped with an exit tube 16.

A valve, 55 and 56 respectively, is mounted so as to close the entry tube 15, and the exit tube 16. When the entry 15 and exit 16 tubes are closed, the valves 55 and 56 allow the circulation of gas through the capillaries from one tube to the other.

The exit tube of the valve 56 is linked to the input of a suction pump 70 so as to allow a sufficient circulation of gases to ensure a measurement in real time.

The downward pumping improves the laminar flow and avoids a pollution by the pump itself (prior sample traces).

The exit signal of the microphone 20 disposed on the tube 50 receiving the laser beam 13A is sent on the positive input of a differential amplifier 18. The exit signal of the second microphone 21, disposed on the parallel tube 51 which is not placed in the body of the last beam 13A, is sent on the negative input of the differential amplifier 18.

The exit of this amplifier 18 delivers electric signals representative of the quantity of gas detected at a central processing unit 19 equipped with a display screen. The device also comprises an electronic unit 17 which controls modulators 12A and 12B, in such a way that one of the laser beams 13A and 13B is modulated during each measurement time interval.

In a variant of embodiment, modulators 12A and 12B are integrated to the sources 11A and 11B, respectively. The modulation produces electronically, by modulation of the laser diode's excitation current. In other versions, modulators 12A and 12B are mechanical and placed on the optical path of the laser beams exiting the sources 11A and 11B, respectively.

In the container 14, the photoacoustic signal, in the case of weak absorptions (α L<<1) is given by the following equation:

S_{PA}=R W α

Where R, the response of the container, is proportional to the quality factor Q, W is the power of the laser, a the rate of gas absorption and L, the distance travelled by the light beam in the gas.

Preferentially, to improve the photoacoustic signal, the quality factor Q is increased by choosing an acoustic resonance amongst the longitudinal, azimuthal, radial, or Helmholtz acoustic resonances.

Amongst the advantages of the Helmholtz photoacoustic container, can be cited:
a high sensitivity, returning weak detectable concentrations,
a weak volume,
an atmospheric pressure efficiency,
a high energy measurement: 5 to 6 decades,
a weak measurement time constant and
a high strength and a limited cost.

An example of application will now be explained, for methane detection. To detect this gas, the laser, for example a laser diode, is preferentially chosen with a wavelength of 1.65 microns or 7.9 microns (notably with a QCL laser). The modulation frequency is chosen so that it is located at the maximum level of response in amplitude of the resonant container, this maximum level corresponding to a response opposite to the phase of signals delivered by the second microphone 21 in relation to signals delivered by the first microphone 20. The maximum level of amplitude response is located at the acoustic resonance frequency of the container. For this value of frequency, the signals delivered by the second microphone 21 are opposite to the phase in relation to the signals delivered by the first microphone 20. These signals are therefore added in the amplifier 18 and produce at the exit, an amplitude signal higher in both the container closed on the exterior, as represented by the signal 61 of FIG. 5A, and the container open on the exterior, as represented by the signal 62 of FIG. 5B.

Thus, with a resonant container 14 of very weak dimensions, around a square being 10 cm sideways, with the tubes having a diameter ratio of 1 to 10 and a capillary volume in relation to the volume of the tubes having a volume ratio of 1 to 100, a high detection sensitivity can be obtained. The device thus allows to detect the presence of the methane with a concentration in the order of a part per million (or “ppm”), around 1.65 microns with a conventional laser diode and in the order of a part per billion (or “ppb”) with a quantum cascade laser.

Thus, the photoacoustic measurement device of the presence of a gas comprises of:

a Helmholtz resonant container 14 composed of at least two tubes 50 and 51 closed at their respective ends and linked together, close to each of their ends, by capillary tubes 53 and 54 of a diameter lower than the diameter D of the parallel tubes and

an introduction means 55, 56 and 70 of the gas in the said container,

at least two radiant laser energy sources 11A and 11B adapted to supply an excitation energy to the gas contained in the container 14, of which the emission wavelength corresponds to a maximum absorption wavelength for the said gas, each said radiant energy source being positioned opposite a window closing a tube end,

a modulation means 12A, 12B, 17 which modulates the excitation energy supplied for each of the laser energy sources 11A and 11B with a modulation frequency in correspondence with (preferentially equal to) the acoustic resonance frequency of the resonant container 14 and

at least an acoustoelectric transducer 20, 21 disposed on one of the tubes to detect the acoustic signals produced in this tube and supply, at the exit of the differential amplifier 18, an electric signal representative of the concentration of the gas in the container 14.

In another embodiment, the device is mounted on a vehicle, the input tube 15 communicating with the exterior of the vehicle and sucking the air to make detections of gas to detect.

Preferentially, by the choice of wavelengths of different laser sources, the photoacoustic gas analysis device is adapted to simultaneously detect/measure a plurality of gas.

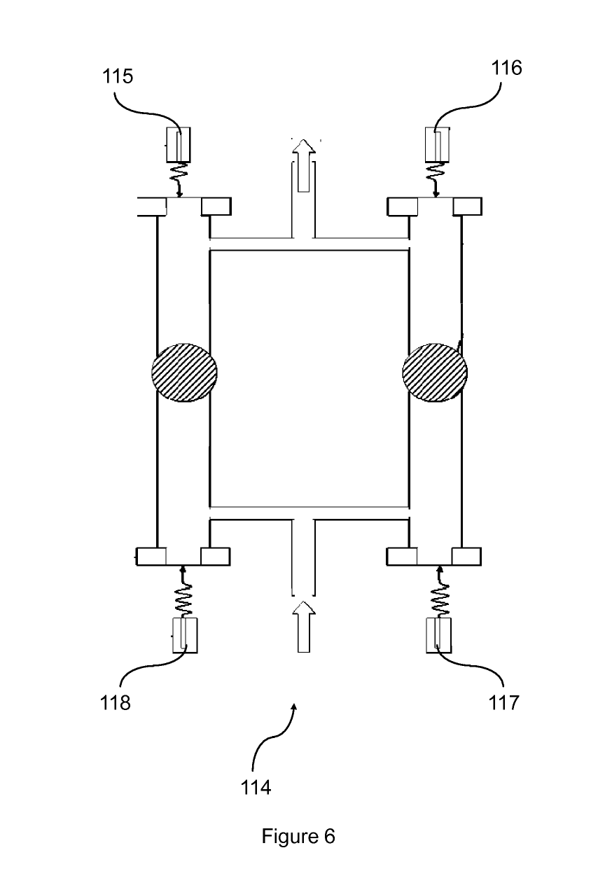

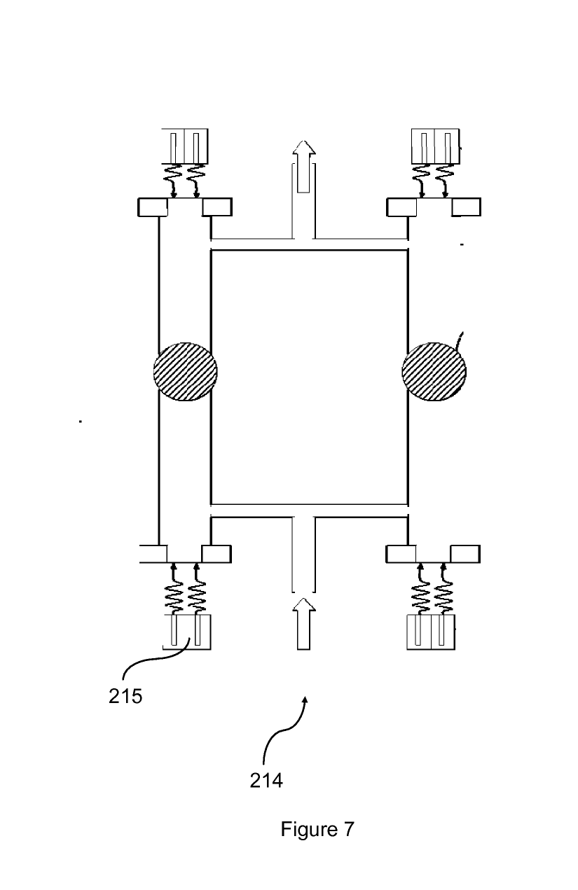

In the embodiment illustrated in FIG. 6, cellular symmetry 114 is implemented to position at least four lasers 115, 116, 117 and 118, of different wavelengths corresponding to:
absorption peaks of different gases which allow the detection and/or the measurement of concentration of a plurality of different gases and/or
different absorption peaks of a same gas, which allow a more precise detection analysis and/or measurement of concentration of this gas, than if a single absorption peak was processed.

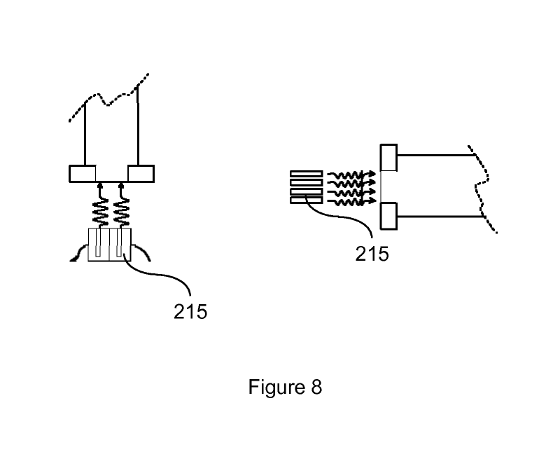

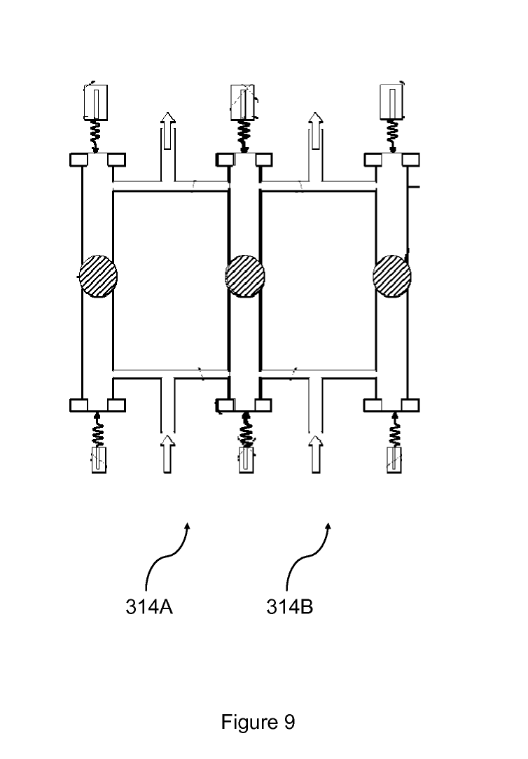

In the embodiments, such as that illustrated in FIGS. 7 and 8, flexibility in the positioning of the connection of a laser in a photoacoustic container 214 is implemented, by assembling several lasers 215, here eight, opposite at least one window, here four windows at the ends of the tubes, which reduce the number of analysed gases. As illustrated in FIG. 8, the assembly of the lasers is thus achieved in accordance with their geometry, and the geometry of the window, following the horizontal and on the vertical (two piles of four lasers, each, in FIGS. 7 and 8).

In embodiments, such as that illustrated in FIG. 9, at least two containers 314A and 314B sharing a tube are implemented, which thus allows to reduce substantially the volume, while increasing the number of lasers, and therefore increasing the analysed gases.

The different embodiments explained above can be combined to form a device to measure the quantity of at least one gas comprising of multiple laser sources.

The present invention applies notably to the scientific or industrial instrumentation, concerning the following domains:
oil, gas, food-processing, semiconductors . . .
control of industrial processes and good operation of installations

In the environmental domain, the present invention allows the control of emission affecting the environment (air, farming, infrastructures . . . ).

In the domain of defence and security, the present invention allows the detection of toxic and explosive agents, and other illicit substances.

In the medical domain, the present invention concerns the detection of pioneering illness agents (Cancer, Asthma, Glucose . . . ).

Thanks to the implementation of the present invention, we can:
detect 1 molecule per billion, or ppb (acronym of “part per billion”), even 1 molecule per trillion, or ppt (1 ppt=0.001 ppb),
detect variations of the same approximate size,
with a good selectivity, multi-gas: Methane, NH₃, Ethylene, H₂S, N₂O . . . and
obtain portable or integrated instruments and a low or lesser cost.

Additionally, the operation of the flow system, at a weak time constant, allows very simple optical adjustments and avoids the passing of many laser beams that weo find in direct spectroscopy.

Preferentially, an improved detectivity is implemented by using efficient microphones, of up to 3.3 10⁻¹⁰ W.cm⁻¹.

We detail below, applications of the present invention for the detection of methane (CH₄), specifically for the mining industry and the analysis of urban gases. For these applications, the fundamental bands n₄ and n₂ around 1400 cm⁻¹ (that is a wavelength slightly longer than 7 μm), the fundamental bands n₁ and n₃ around 3000 cm⁻¹ (that is a wavelength of around 3.3 μm), the harmonic band (n₄ or n₂)+(nᵢ or n₃) around 4400 cm⁻¹ (that is a wavelength of around 2.3 μm), the harmonic band 2n₃ around 6000 cm⁻¹ (corresponding to 1.65 μm) can be implemented.

For the detection of methane with a laser diode, the inventors have obtained the following results:
with a IBSG (registered trademark) laser, emitting to 1.65 μm: 300 ppm,
with a Sensor Unlimited (registered trademark) laser, emitting to 1.65 μm: 1 ppm,
with a laser from Montpellier University, emitting to 2.3 μm: 50 ppm,
with a laser mounted in an external Sacher (registered trademark) cavity, emitting to 1.65 μm: 0.3 ppm and
with an Alpes lasers (registered trademark) quantum cascade laser, emitting to 7.9 μm: 17 ppb and 3 ppb (with cryostat).

In embodiments, a liquid nitrogen cryostat is implemented.

We observe that the nitrous oxide (N₂O) can also be detected and quantified.

We detail below, the applications of the present invention for the detection of nitrogen monoxide (NO), notably for the domains of environment (atmospheric chemistry, measurement of pollution . . . ), of security (nitrogen monoxide is a gas emitted by trinitrotoluene or TNT explosives), of medicine (nitogen monoxide is a marker of inflammations such as asthma). For these applications, the fundamental band (1-0) around 1900 cm⁻¹ (corresponding to 5.3 μm in wavelength), the harmonic band (2-0) around 3800 cm⁻¹ (that is 2.6 μm in wavelength) can be implemented.

The inventors have detected nitrogen monoxide with a QCL quantum cascade laser emitting to 5.4 μm, operating in liquid nitrogen with a power of 2.6 mW: 20 ppb. With a same type of laser with a more powerful emission, operating at room temperature: 1 ppb.

Notably, to constitute a portable gas analysis instrument, preferentially, the implemented laser operates at room temperature.

We note that with the implementation of the present invention, all the gases absorbing the infrared are accessible for the detection and/or the measurement of concentration.

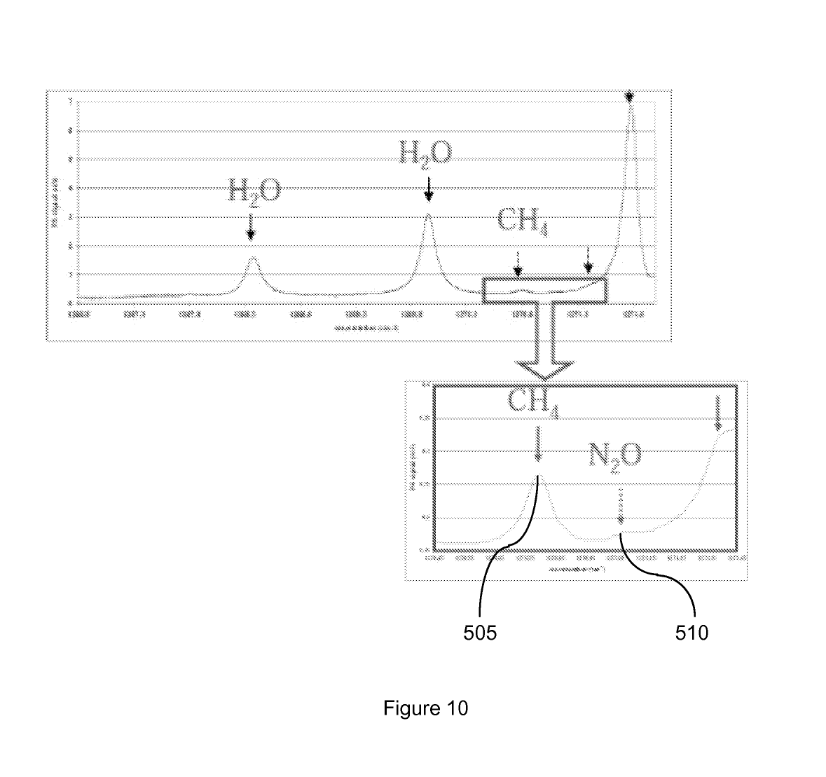

We observe, in FIG. 10, that methane and nitrous oxide can be detected in the air containing water vapour, by choosing specific peaks 505 and 510 respectively.

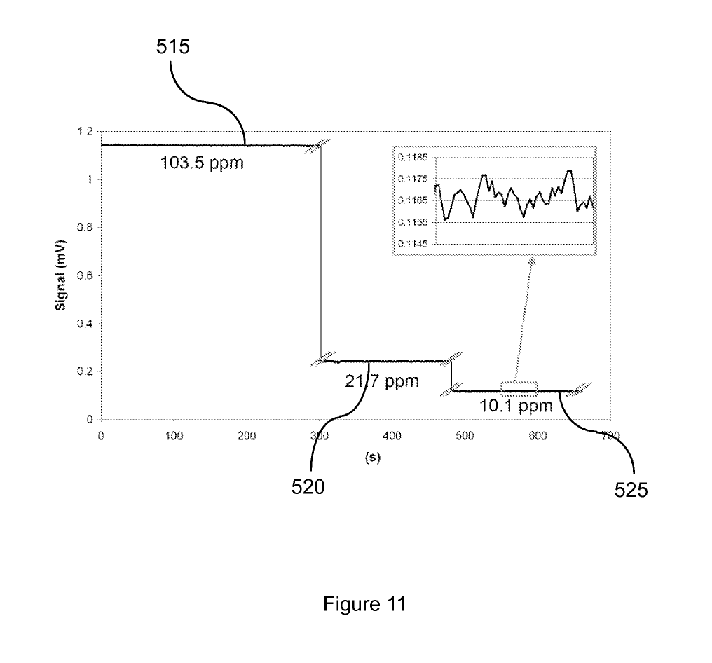

FIG. 11 shows the signals 515, 520 and 525 picked up at the exit of an acoustoelectric transducer 20 or 21 for different concentrations of known gases (103.5 ppm, 21.7 ppm and 10.1 ppm, respectively). The average amplitude of these signals allows to verify the linearity between these signals and these concentrations.

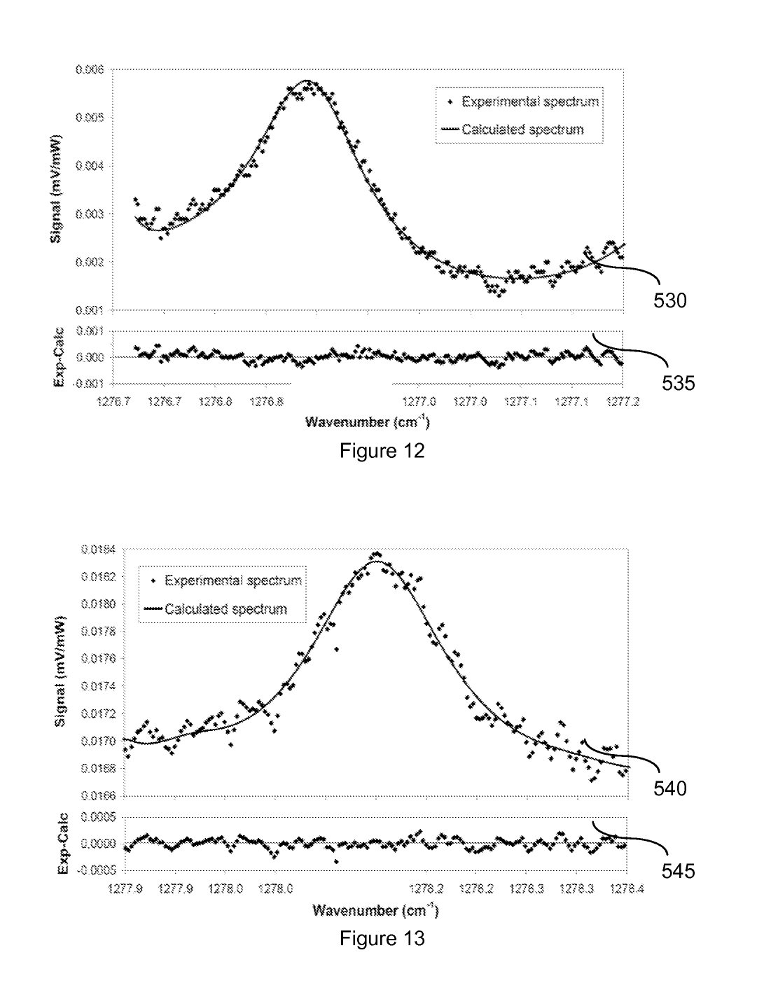

FIG. 12 shows the absorption adjustment 530 of methane in air flow. The inversion 535 of this spectrum 530 recorded to 7.9 microns allows to recalculate the 1.85 ppm of methane in the ambient air.

FIG. 13 shows the absorption adjustment 540 of nitrous oxide in air flow. The inversion 545 of this spectrum 540 recorded to 7.9 microns allows to recalculate the 320 ppb of nitrous oxide in the ambient air.

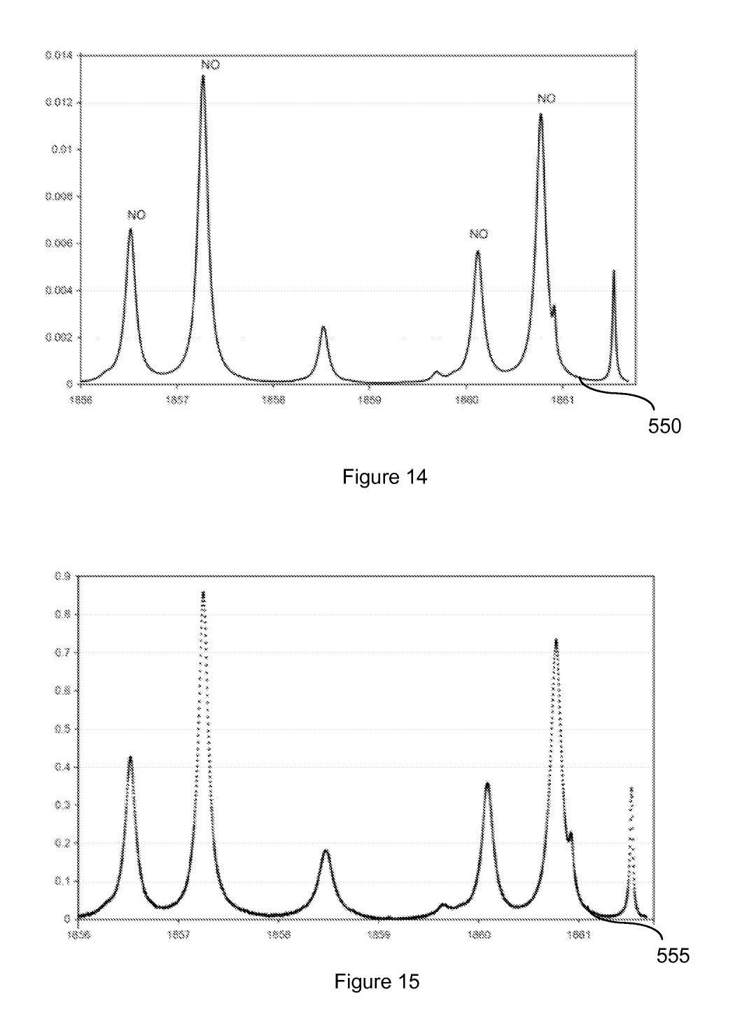

FIG. 14 shows the spectrum 550, calculated from the absorption of ambient air containing 100 ppm of nitrogen monoxide around 5.4 microns.

FIG. 15 represents the spectrum 555, experimentally obtained with the object devices and the object methods of the present invention, in the conditions of FIG. 14.

All these figures demonstrate that the device is adapted whatever the wavelength and whatever the detectable gas.

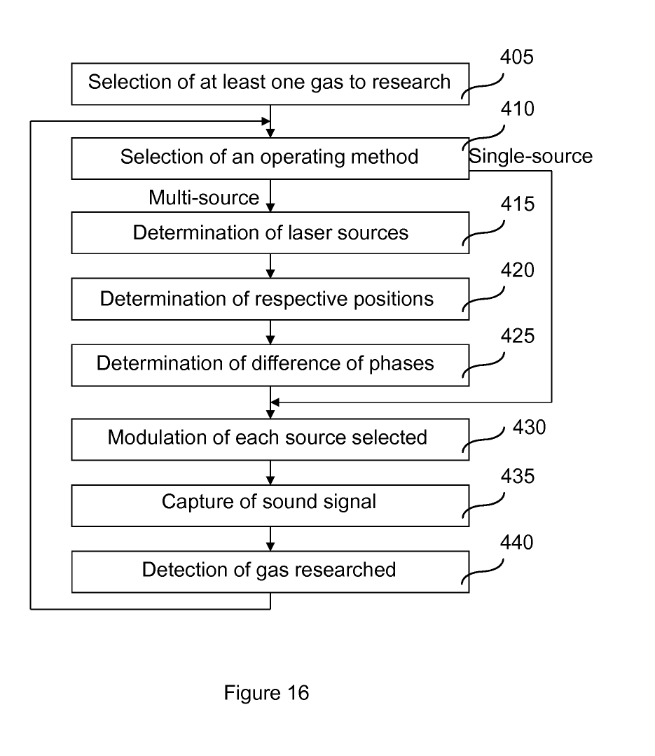

As illustrated in FIG. 16, in a particular embodiment, the process comprises of, firstly, a selection step 405 of at least a gas of which traces are searched for.

Then, gases to detect are processed successively. For example, it starts with the first gas selected during the step 405. The gas to process is called, in the next part of the description of FIG. 16, “common gas”.

For the common gas, during the step 410, it is determined if at least two radiant energy sources of the device correspond with two absorption peaks, characteristic of gas. If yes, the operating method to several sources is selected. If not, the operating method to a single source is selected.

If the multi-source operating method is selected, the steps 415 to 440 are achieved. If the single-source operating mode is selected, step 430 is directly proceeded to.

During the step 415, each of the radiant energy sources corresponding to the common gas is determined. During a step 420, the respective positions of radiant energy sources are determined, that is to say the lines of tubes, for example 50 and 51 in FIG. 1, opposite to which these sources are located.

During the step 425, the phase differences to apply to the different sources are determined. The sources being located opposite tubes in the same line, do not present any phase shift between them. Additionally, the sources being located opposite tubes in odd lines present a phase shift of 180° compared with sources being located opposite tubes in an even line. This phase shift is to apply by the modulation means which modulate the excitation energy supplied by each of the laser energy source with a modulation frequency in correspondence with the acoustic resonance frequency of the resonant container.

During the step 430, the modulation is applied with, in the case of several sources, the phase differences determined during the step 425, to each source selected. During the step 430, thus, the excitation energy supplied by each radiant laser energy source selected is modulated, with a modulation frequency in correspondence with the acoustic resonance frequency of the resonant container, each radiant laser energy source supplying an excitation energy to the gas contained in the container opposite to which this source is located, the wavelength of the source corresponding to a maximum absorption wavelength locally for the common gas. In the case where at least two laser sources supply light to the same wavelength, these laser sources are simultaneously selected and simultaneously modulated with possibly different phases.

During a step 435, the sound signals present in the different tubes is captured and amplified in a differential manner.

During the step 440, in accordance with this differential signal, it is determined if the common gas is present in the tubes of the photoacoustic device and we estimate the quantity of this gas. A resulting signal outputted form at least an acoustoelectric transducer disposed on one of the tubes is thus processed to detect the acoustic signals produced in this tube and supply an electric signal representative of the concentration of gas in the container.

Then the following gas is selected and step 410 is proceeded to.

As it is understood by reading the description in FIG. 16, according to the operating methods of this device:
either at least two radiant laser energy sources are simultaneously implemented to two wavelengths, characteristic of a same gas, which increases the sensitivity of the detection of this gas,
or the radiant laser energy sources are successively implemented at the wavelengths, characteristic of different gases, which allows to quickly switch from the detection of traces of a gas to the detection of traces of another gas, while using a very reduced volume.

Additionally, it is moved from one to the other of these operating methods in accordance with the radiant laser energy sources which correspond to different absorption peaks of a same gas, and radiant laser energy sources which correspond to different absorption peaks of different gases. So, it is enough to switch between the first and second ones to pass the first operating method described above to the second.

1-14. (canceled)

15. A photoacoustic device for measuring the quantity of at least one gas, comprising:
a Helmholtz-type resonant container comprising at least two parallel tubes closed at their ends and linked together, close to their respective ends, by capillary tubes of a diameter less than the diameter of the parallel tubes;
a gas introduction means in the resonant container;
at least two radiant laser energy sources, each physically separated and adapted to supply an excitation energy to the gas contained in the container at a different emission wavelength, each corresponding to a maximum absorption wavelength locally for each gas, each laser energy source being positioned opposite a window closing an end of a parallel tube,
a modulator for modulating the excitation energy supplied by each laser energy source with a modulation frequency corresponding to an acoustic resonance frequency of the resonant container; and
at least one acoustoelectric transducer, disposed on one of the parallel tubes to detect acoustic signals produced therein and to supply an electric signal representative of the gas concentration in the resonant container.

16. A device according to claim 15, wherein the modulator is adapted to simultaneously modulate the excitation energy supplied by at least two laser energy sources.

17. A device according to claim 16, wherein the modulator applies a phase shift of 180° between the excitation energies of the laser energy sources positioned opposite windows of successive parallel tubes.

18. A device according to claim 17, wherein the said at least two laser energy sources have emission wavelengths corresponding to absorption peaks of a same gas.

19. A device according to claim 16, wherein the said at least two laser energy sources have emission wavelengths corresponding to absorption peaks of a same gas.

20. A device according to claim 15, wherein said at least two radiant laser energy sources are positioned opposite different windows.

21. A device according to claim 15, wherein said at least two radiant laser energy sources are positioned opposite a same window.

22. A device according to claim 15, wherein said at least two radiant laser energy sources have the emission wavelengths corresponding to a maximum absorption wavelength for two different gases.

23. A device according to claim 15, wherein said at least two radiant laser energy sources have the emission wavelengths corresponding to two maximum absorption wavelengths for the same gas.

24. A device according to claim 15, wherein at least one radiant laser energy source is a quantum cascade-type radiant laser energy source.

25. A device according to claim 15, further comprising at least three parallel tubes forming two resonant containers sharing one parallel tube linked by capillary tubes to other two parallel tubes.

26. A device according to claim 15, wherein the modulator successively modulates the excitation energy supplied by each radiant laser energy source.

27. A process of photoacoustic measurement of the quantity of at least one gas,
utilizing at least two radiant energy sources and Helmholtz-type resonant container comprising at least two parallel tubes closed at their ends and linked together, close to their respective ends, by capillary tubes of a diameter less than the diameter of the parallel tubes and a gas introduction means in the resonant container, each radiant source positioned opposite a window closing an end of a parallel tube;
simultaneously performing the following for each radiant energy source:
modulating an excitation energy supplied by said each radiant laser energy source, with a modulation frequency corresponding to an acoustic resonance frequency of the resonant container, said each radiant laser energy source supplying an excitation energy to the gas contained in the container, the emission wavelength of said each radiant laser energy source corresponding to a maximum absorption wavelength locally for each gas; and
processing a resulting signal of at least one acoustoelectric transducer, disposed on one of the parallel tubes to detect the acoustic signals produced therein and to supply an electric signal representative of the gas concentration in the resonant container.

28. The process according to claim 27, wherein the modulating step further comprises the step of modulating the excitation energy supplied by at least two laser energy sources.

29. The process according to claim 28, wherein the modulating step further comprises the step of applying a phase shift of 180° between the excitation energies of the radiant laser energy sources positioned opposite windows of successive parallel tubes during

30. The process according to claim 27, wherein the modulating step further comprises the step of applying a phase shift of 180° between the excitation energies of the radiant laser energy sources positioned opposite windows of successive parallel tubes during
